(19) United States
(12) Patent Application Publication
(10) Pub. No.: US 2011/0113404 A1
(43) Pub. Date: May 12, 2011

(54) DEVICE AND METHOD FOR OPERATING COMMON MODULE IN SOFTWARE ARCHITECTURE

(75) Inventor: Song-Kyoo KIM, Daegu (KR)

(73) Assignee: SAMSUNG ELECTRONICS CO. LTD., Suwon-si (KR)

(21) Appl. No.: 12/941,438

(22) Filed: Nov. 8, 2010

(30) Foreign Application Priority Data
Nov. 12, 2009 (KR) 10-2009-0109268

(51) Int. Cl. G06F 9/44

(52) U.S. Cl. 717/121

(57) ABSTRACT

A device for operating a common module in a software architecture efficiently operating a software module using a closed M/G/1 queuing model of an extended form and a concept of a super-reserve module, and a method thereof are provided. The device includes a plurality of common modules for operating an application module, a plurality of backup modules for substituting for a crashed common module; and a module generating unit for substituting one of the plurality of backup modules for the crashed common module and for generating an additional plurality of backup modules when the plurality of backup modules are all substituted.

### PRIORITY

This application claims the benefit under 35 U.S.C. §119(a) of a Korean patent application filed in the Korean Industrial Property Office on Nov. 12, 2009 and assigned Serial No. 10-2009-0109268, the entire disclosure of which is hereby incorporated by reference.

### BACKGROUND OF THE INVENTION

1. Field of the Invention

The present invention relates to a device and a method for operating a common module in a software architecture. More particularly, the present invention relates to a device for operating a common module in a software architecture efficiently operating a software module using a closed M/G/1 queuing model of an extended form and a concept of a super-reserve module, and a method thereof.

2. Description of the Related Art

Software architecture typically includes distributed (modular) architecture for stable operation of software. The software architecture includes a core module, a common module, and an application module. Java Virtual Machine (JVM) or Common Object Request Broker Architecture (CORBA) are examples of common modules.

The modules have the structure mentioned above for application compatibility. Although measures for protecting or restoring software modules have been currently developed, methods for managing the software modules have not been disclosed.

Although programs exist for coping with software faults, methods for managing systems and mathematically proving their effects have not been suggested. A method for making and designating a code is one protection/recovery method when a software module crashes. However, this method may crash a module and cannot restore a crashed module, and may not recover the crashed module. According to another method, modules are copied in a predetermined amount of a memory. When a fault occurs, a backup module is copied and used. However, in this case, when all backup modules are used, a system is inevitably turned-off.

### SUMMARY OF THE INVENTION

An aspect of the present invention is to address the above-mentioned problems and/or disadvantages and to provide at least the advantages described below. Accordingly, an aspect of the present invention is to provide a device for operating a common module in a software architecture efficiently operating a software module using a closed M/G/1 queuing model of an extended form and a concept of a super-reserve module, and a method thereof.

In accordance with an aspect of the present invention, a device for operating a common module in a software architecture is provided. The device includes a plurality of common modules for operating an application module; a plurality of backup modules for substituting for a crashed common module, and a module generating unit for substituting one of the plurality of backup modules for the crashed common module and for generating an additional plurality of backup modules when the plurality of backup modules are all substituted.

In accordance with another aspect of the present invention, a method for operating a common module in a software architecture is provided. The method includes determining whether a common module among a plurality of operated common modules has crashed, substituting one of a plurality of backup modules for the crashed common module when the common module crashes, and generating an additional plurality of backup modules when the plurality of backup modules are all substituted.

In accordance with another aspect of the present invention, a method of operating a plurality of common modules in a software architecture is provided. The method includes setting an initial number of operating common modules and an initial number of backup modules, when a common module has crashed, substituting one of the backup modules for the crashed common module, and reducing a number of available backup modules by one, and when a total number of operating common modules and available backup modules is less than or equal to the initial number of backup modules, generating an additional plurality of backup modules.

As mentioned above, an aspect of the present invention is to provide a device for operating a common module in a software architecture efficiently operating a software module using a closed M/G/1 queuing model of an extended form and a concept of a super-reserve module, and a method thereof. Accordingly, upon configuring a common module, a backup module is grouped and generated, thereby efficiently performing an operation.

Further, an aspect of the present invention is to provide factors judging a performance of a product to thereby obtain a better environment to make a decision. In addition, the present invention is applicable to a software environment and other products in the same manner.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a software architecture according to an exemplary embodiment of the present invention;

FIG. 2 is a view illustrating a device for operating a common module in a software architecture according to an exemplary embodiment of the present invention; and

FIG. 3 is a flowchart illustrating a method for operating a common module in a software architecture according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

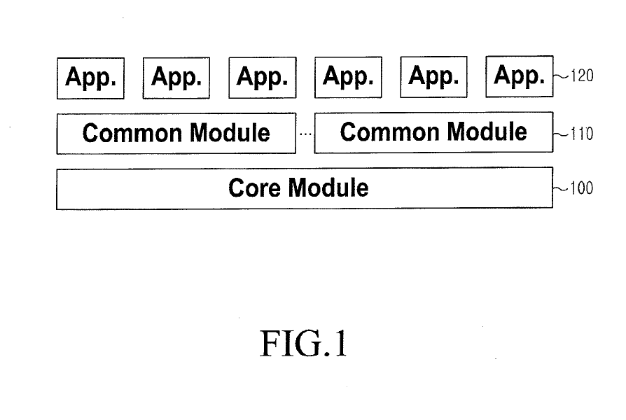

FIG. 1 is a view illustrating a software architecture according to an exemplary embodiment of the present invention.

Referring to FIG. 1, the software architecture includes a core module 100, a plurality of common modules 110, and a plurality of application modules 120. The core module 100 is the lowermost kernel of an Operating System (OS), and is operated most stably, which directly connects with a system (H/W). The plurality of common modules 110 are located at a higher layer than the core module 100, and organically operate an application. The common module 110 may be, for example, a Java Virtual Machine (JVM) or a Common Object Request Broker Architecture (CORBA). The plurality of application modules 120 represent programs that directly interact with the user.

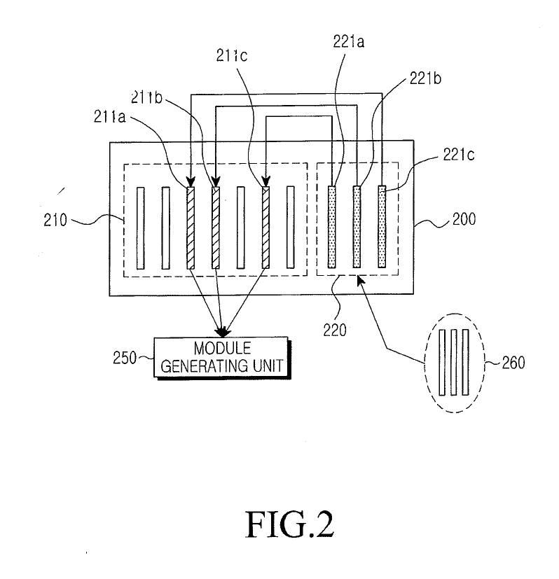

FIG. 2 is a view illustrating a device for operating a common module in a software architecture according to an exemplary embodiment of the present invention.

Referring to FIG. 2, the device for operating a common module in a software architecture includes a storage unit 200 and a module generating unit 250. The storage unit 200 includes a first storing part 210 storing a plurality of common modules operating an application module, and a second storing part 220 storing a plurality of backup modules substituting for a crashed common module of the plurality of common modules.

When common modules 211a, 211b, and 211c crash, the module generating unit 250 substitutes backup modules 221a, 221b, and 221c stored in the second storing part 220 for the crashed common modules 211a, 211b, and 211c. When the plurality of backup modules 211a, 211b, and 211c are all substituted and used, the module generating unit 250 groups and generates an additional plurality of backup modules 260.

Each time a common module crashes, the module generating unit 250 substitutes one of the backup modules 221a, 221b, and 221c, one by one. When all the backup modules are substituted and used, the module generating unit 250 simultaneously generates super-reserve modules (e.g., the additional plurality of backup modules 260) at one time.

If the operating common modules and the backup modules are configured in a ratio of (m+1):s, when (m+1) operating common modules crash, one of s backup modules is substituted therefor. Unlike general closed M/G/1 queuing models instantly starting a repair each time the common module crashes, after the module generating unit 250 uses all the corresponding reserve modules (backup modules), a repair operation of the super-reserve modules starts. When s common modules crash (the number of operating modules remains m+1), the module generating unit 250 simultaneously generates an additional s backup modules at one time.

The module generating unit 250 sets an initial value (m_{—}0) of the number of operating common modules, an initial value (S_{—}0) of the number of the backup modules, an initial value (T_{—}0) of the number of total common modules, and an initial repetition value (n). The initial value (T_{—}0) is a sum of the initial value (m_{—}0) and the initial value (S_{—}0). The initial value (S_{—}0) may be an optimal number for protecting the operating common modules.

The module generating unit 250 judges that the initial (S_{—}0) backup modules are used when the initial value (T_{—}0) is less than or equal to the initial value (m_{—}0), and groups and generates an additional (S_{—}0) backup modules.

The module generating unit 250 determines the number (C_s) of common modules that crashed during the generation of the additional (S_{—}0) backup modules; and generates a number (m−(n+1)) of common modules obtained by subtracting the number (C_s) of crashed common modules from the number (m_n) of currently operating common modules, the number (S_(n+1)) of backup modules having the initial value (S_{—}0) of the number of the backup modules, and a number (T_(n+1)) of total common modules when the generation of the initial value (S_{—}0) of the number of the backup modules is terminated. The value (T_(n+1) is a sum of the number (m−(n+1)) of common modules and the number (S_(n+1)) of backup modules.

The module generating unit 250 repeatedly performs a common module operating procedure through the generated number (m−(n+1)) of common modules, the generated number (S_(n+1)) of backup modules, and the generated number (m−(n+1)) of common modules.

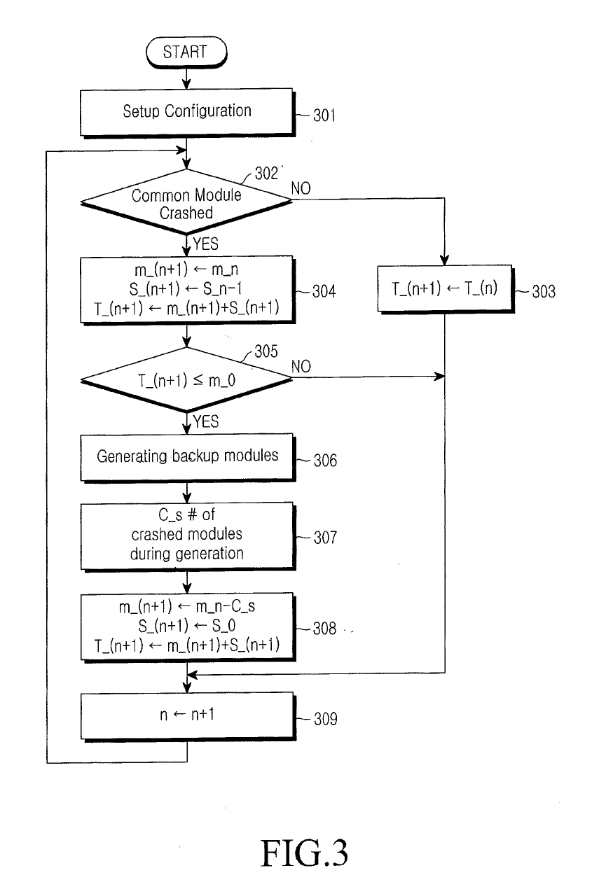

FIG. 3 is a flowchart illustrating a method for operating a common module in a software architecture according to an exemplary embodiment of the present invention.

Referring to FIG. 3, a module generating unit 250 sets an initial value for operating a common module at step 301. At step 301, the module generating unit 250 sets an initial value (m_{—}0) of the number of operating common modules, an initial value (S_{—}0) of the number of the backup modules, an initial value (T_{—}0) of the number of a total common modules, and an initial repetition value (n). The initial value (T_{—}0) is a sum of the initial value (m_{—}0) of the number of operating common modules and the initial value (S_{—}0) of the number of the backup modules. The generated initial values may be set by applying optimal values using mathematical programming, which can be calculated through the following equations.

The closed M/G/1 queuing model refers to a case where a probability distribution with respect to a time taken to generate a backup module is not a general distribution function but an exponential random distribution. A cost function per unit time is assumed as a linear function and is defined by Equation (1) below.

f(n)=c₁·n,g(n)=c₂·n,h(μ)=c·μ (1)

In Equation (1), c₁ represents a cost per operated common module, c₂ represents a cost required to substitute one crashed common module, c represents a cost of generating/storing a backup module for backup, u represents a unit time, and n represents the number of modules. Accordingly, an object cost function can be summarized as in Equation (2) defined below.

f(n)=c₁·n,g(n)=c₂·n,h(μ)=c·μ (2)

A detailed expression can be expressed by Equation (3) defined below.

$$E [ {Z}_{∞}^{1} ] = \frac{m + ( s + 1 ) {P}_{m} + ms + {P}_{m}}{am μ + {P}_{m} ( s + 1 )} {P}_{m} = \frac{{( a μ )}^{m} / m !}{{\sum }_{i = 0}^{m} {( a μ )}^{i} / i !} \qquad ( 3 )$$

In Equation (3), Pₘ represents a probability when the number of operated common modules is m, s is the number of backup modules, a represents an average time required to generate a backup module, μ represents the number of crashed common modules per unit time, and πₖ¹ represents a probability when the number (Zₜ¹) of operated common modules by times is k where a system is stabilized, namely, a time (t) is set to an infinity.

In an M/M/I queuing modeling case, required factors have a first average time to generate a backup module and a second average time of crashed common modules per unit time. The first and second average times can be obtained using suitable statistical data. Other conditions can be determined by a person with the power to make such a decision and may include variations in a market in which the system is used.

An optional simulation will be described for a more substantial application. In this example, a software architecture available for next generation network equipment is manufactured. The software architecture depends on a software architecture according to an exemplary embodiment of the present invention. The software architecture according to an exemplary embodiment of the present invention applied to the next generation network equipment may employ three common modules. At least three common modules should operate in the software architecture and the software architecture should have a reliability of at least 50% for a design.

According to statistical data, an average of one common module crashes every fifteen hours, and one hour is required to newly generate crashed common modules. A maintenance cost per time with respect to an operated common module may be ten thousand Korean won (i.e., about $10), a repair cost per time with respect to a crashed common module may be twenty thousand Korean won (about $20), and a management cost per unit time with respect to a backup module may be thirty thousand Korean won (about $30).

In this case, plan mathematical modeling can be defined by Equation (4) below.

$$Object : \\ min Z ( m ) = 2 ( m + 1 + s ) - E [ {Z}_{∞}^{1} ] + 3 \cdot \frac{{P}_{m} ( am μ + s + 1 )}{am μ + {P}_{m} ( s + 1 )} \\ Subject to : \\ r \cdot ( s + 1 ) \leq 100 , r = 10 m + 1 \geq 3 e \geq 0.50 ( reliability policy ) \qquad ( 4 )$$

Further, required factors may have values illustrated in Equation (5) below.

$$a = 1 , μ = \frac{1}{15} , {c}_{1} = 1 , {c}_{2} = 2 , c = 2 \qquad ( 5 )$$

A value s minimizing an object function can be set through a simple calculation using a computer, and the set value s determines a ratio of m+1:s. In the calculation, the software architecture has a reliability of at least 50%, a value s with an optimized cost becomes four, and a required cost in this case becomes −829 won (i.e., about $1).

Furthermore, as illustrated previously, in a case of an optional simulation, an initial value may be set in such a way that m_{—}0=3, S_{—}0=4, T_{—}0=7, and n=0 at step 301.

When an initial value for operating a common module is set at step 301, the module generating unit 250 determines whether a common module among a plurality of operating common modules has crashed at step 302. When no common module has crashed, the module generating unit 250 repeatedly determines whether a common module has crashed through steps 303 and 309.

Conversely, when a common module has crashed, the module generating unit 250 senses the crash at step 302 and substitutes one of a plurality of backup modules for the crashed common module at step 304. At step 304, the module generating unit 250 maintains and stores the number of current common modules (m_(n+1)←m_n), and stores the number of backup modules obtained by subtracting one backup module substituted for the crashed common module from a plurality of backup modules (S_(n+1)←S_n−1). The number of total common modules is a sum of the number of current common modules and the number of current backup modules (S_(n+1)←S_n−1).

The module generating unit 250 compares the number of (T_(n+1)) of the total common modules with the initial number (m_{—}0) of the operating common modules. When the number of (T_(n+1)) of the total common modules is not less than or equal to the initial number (m_{—}0) of the operated common modules, the module generating unit 250 repeatedly performs step 309 and steps 302 to step 305.

When the number of (T_(n+1)) of the total common modules is less than or equal to the initial number (m_{—}0) of the operating common modules, the module generating unit 250 determines whether the initial number (S_{—}0) of backup modules are substituted and used at step 305. If the initial number (S_{—}0) of backup modules have been substituted, then the module generating unit 250 groups and generates an additional (S_{—}0) backup modules at step 306.

The module generating unit 250 determines whether a common module has crashed during the grouping and generating of the additional (S_{—}0) backup modules at step 306.

When a common module crashes during the generation of the additional backup modules, the module generating unit 250 stores the number (C_s) of crashed common modules occurring during the generation of the additional backup modules at step 307.

When the generation of additional backup modules is completed, the module generating unit 250 stores the number (m_(n+1)) of common modules obtained by subtracting the number (C_s) of crashed common modules from the number (m_n) of currently operating common modules, the number (S_(n+1)) of backup modules having the initial value (S_{—}0) of the number of the backup modules, and the number (T_(n+1)) of total common modules at step 308. The number (T_(n+1)) represents a sum of the number (m_(n+1)) of common modules and the number (S_(n+1)) of backup modules.

Through the number (m_(n+1)) of common modules, the number (S_(n+1)) of backup modules, and the number (T_(n+1)) of total common modules of step 308, the module generating unit 250 repeatedly performs step 302 to step 309 to execute a common module operating procedure.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A device for operating a common module in a software architecture, the device comprising:
a plurality of common modules for operating an application module;
a plurality of backup modules for substituting for a crashed common module; and
a module generating unit for substituting one of the plurality of backup modules for the crashed common module and for generating an additional plurality of backup modules when the plurality of backup modules are all substituted.

2. The device of claim 1, wherein the module generating unit sets an initial value (m_{—}0) of a number of the plurality of operating common modules, an initial value (S_{—}0) of a number of the plurality of the backup modules, an initial value (T_{—}0) of the number of total common modules, and an initial repetition value (n), and
wherein the initial value (T_{—}0) denotes a sum of the initial value (m_{—}0) and the initial value (S_{—}0).

3. The device of claim 2, wherein the module generating unit determines that the initial value (S_{—}0) of the backup modules is used when the initial value (T_{—}0) is less than or equal to the initial value (m_{—}0), and groups and generates the additional (S_{—}0) backup modules.

4. The device of claim 2, wherein the module generating unit determines a number (C_s) of common modules crashed during generation of additional (S_{—}0) backup modules; and
wherein, when the generation of the additional (S_{—}0) backup modules is terminated, the module generating unit generates a number (m_(n+1)) of common modules obtained by subtracting the number (C_s) from a number (m_n) of currently operating common modules, a number (S_(n+1)) of backup modules having the initial value (S_{—}0) of the number of the backup modules, and a number (T_(n+1)) of total common modules being a sum of the number (m_(n+1)) of common modules and the number (S_(n+1)) of backup modules; and
wherein the module generation unit repeatedly performs a common module operating procedure through the generated number (m_(n+1)) of common modules, the generated number (S_(n+1)) of backup modules, and the generated number (m−(n+1)) of common modules.

5. The device of claim 2, wherein the initial value (S_{—}0) is an optimal number for protecting the operating common modules.

6. A method for operating a common module in a software architecture, the method comprising:
determining whether a common module among a plurality of operating common modules has crashed;
substituting one of a plurality of backup modules for the crashed common module when the common module crashes; and
generating an additional plurality of backup modules when the plurality of backup modules are all substituted.

7. The method of claim 6, further comprising:
setting an initial value (m_{—}0) of a number of the operating common modules before determining whether a common module has crashed;
setting an initial value (S_{—}0) of the number of the backup modules before determining whether a common module has crashed;
setting an initial value (T_{—}0) of a number of total common modules, the initial value (T_{—}0) being a sum of the initial value (m_{—}0) and the initial value (S_{—}0), before determining whether a common module has crashed; and
setting an initial repetition value (n) before determining whether a common module has crashed.

8. The method of claim 6, wherein the generating of the additional plurality of backup modules comprises:
determining that the initial value (S_{—}0) of the backup modules is used when the initial value (T_{—}0) of the number of total common modules is less than or equal to the initial value (m_{—}0) of the number of operating common modules to group; and
generating an additional (S_{—}0) backup modules.

9. The method of claim 8, further comprising:
identifying a number (C_s) of common modules that crashed during the generating of the additional (S_{—}0) backup modules;
when the generating of the additional (S_{—}0) backup modules is terminated, generating a number (m_(n+1)) of common modules obtained by subtracting a number (C_s) of crashed common modules from a number (m_n) of currently operating common modules;
when the generating of the additional (S_{—}0) backup modules is terminated, generating a number (S_(n+1)) of backup modules having the initial value (S_{—}0);
when the generating of the additional (S_{—}0) backup modules is terminated, generating a number (T_(n+1)) of total common modules, the number (T_(n+1) being a sum of the number (m_(n+1)) of common modules and the number (S_(n+1)) of backup modules; and
repeating a common module operating procedure through the generated number (m_(n+1)) of common modules, the generated number (S_(n+1)) of backup modules, and the generated number (m_(n+1)) of common modules.

10. The method of claim 6, wherein the initial value (S_{—}0 is an optimal number for protecting the operated common modules.

11. A method of operating a plurality of common modules in a software architecture, the method comprising:
setting an initial number of operating common modules and an initial number of backup modules;
when a common module has crashed, substituting one of the backup modules for the crashed common module, and reducing a number of available backup modules by one; and
when a total number of operating common modules and available backup modules is less than or equal to the initial number of backup modules, generating an additional plurality of backup modules.

12. The method of claim 11, wherein the number of additional generated backup modules corresponds to the initial number of backup modules.

13. The method of claim 11, further comprising:
adjusting the number of operating common modules and the number of available backup modules based on the amount of additional generated backup modules.

14. The method of claim 13, further comprising:
after the generating of the additional plurality of backup modules, determining whether any operating common modules have crashed during the generation of the additional plurality of backup modules; and
when an operating common module has crashed during the generation of the additional plurality of backup modules, substituting a backup module for a crashed common module, and adjusting the number of available backup modules, the number of operating common modules, and the total number of operating common modules and available backup modules based on the result of the substitution.
